(19) United States
(12) Patent Application Publication
(10) Pub. No.: US 2014/0022584 A1
(43) Pub. Date: Jan. 23, 2014

(54) Print Driver Expediency Selection

(71) Applicant: Brent R. Jones, Sherwood, OR (US)

(72) Inventor: Brent R. Jones, Sherwood, OR (US)

(73) Assignee: XEROX CORPORATION, Norwalk, CT (US)

(21) Appl. No.: 13/552,053

(22) Filed: Jul. 18, 2012

(51) Int. Cl. G06K 15/02

(52) U.S. Cl. 358/1.14; 358/1.15

(57) ABSTRACT

A printer includes a control system configured to receive an expediency selection signal when the printer is in a low energy state indicating that a print job can be performed prior to completion of a warm-up process. Upon receiving an expediency selection signal, a controller selectively performs an expedited printing process to enable faster printing when print image quality can be compromised.

### TECHNICAL FIELD

This disclosure relates generally to printers, and more particularly to printers that are selectively operated to print an image in an expedited manner.

### BACKGROUND

Various types of printers are commonly used in industry to form images on print media such as paper. Common examples of printers include laser printers, LED printers, and drop-on-demand ink printers, such as inkjet printers, which may employ aqueous, emulsified, gel, or phase change inks. While these various printing devices may employ different techniques to form images on print media, common printing devices consume electricity to operate and, in some cases, heat printer components to particular temperatures, which are selected to facilitate optimal print quality. The temperatures of various printer components, and thus the rates of energy consumption, vary during imaging operations, during printer maintenance operations, and also during periods of inactivity between imaging operations.

For example, in an indirect inkjet printer 300, shown in FIG. 3 one or more printheads 304 each contain an array of individual nozzles through which drops of ink 308 are ejected by inkjets across an open gap onto an image receiving member 312 to form an ink image during printing. Print media 316 then passes through a nip 320 formed between the image receiving member 312 and a transfix roller 324. As the print media 316 passes through the nip 320, the image receiving member 312 and the transfix roller 324 apply heat and pressure to the print media 316 to transfix the ink image onto the print media 316 to form the final printed image.

In this arrangement, prior to being ejected by inkjets, ink heating stations 328 heat the ink 308 to a temperature within an acceptable range of temperatures to ensure proper consistency and viscosity. Additionally, a heater unit 332 heats the image receiving member 312 to a temperature within an acceptable range of temperatures for receiving the ink and maintaining the ejected ink at a proper temperature on the surface of the image receiving member 214. Additionally, a pre-heater 336 heats the print media 316 to a temperature within an acceptable range of temperatures prior to entering the nip 320 to ensure proper transfer of the ink 308 to the print media 316. Additionally, the transfix roller 324 and the image receiving member 312 are heated to temperatures within respective acceptable ranges of temperatures to ensure proper transfixing of the ink image onto the print media 316. Finally, after the ink 308 has been transfixed onto the print media 316, a fusing heater 340 heats the print media 316 and the ink 308 to a temperature within a range of acceptable temperatures that ensure proper fusing and spreading of the ink droplets 308 on the print media 316 to form the final printed image of normal quality.

To illustrate the amount of energy the printer expends heating the above described printer components, in one embodiment, a controller 344 is operably connected to the ink heating stations 328, which may be a reservoir integrated with or separate from a printhead, the image receiving member heater unit 332, the media pre-heater 336, and, as may be used in some product configurations, a fusing heater 350. The controller 344 is configured to operate the ink heating stations 328 to heat one exemplary ink formulation to approximately 110 to approximately 120 degrees Celsius. The controller 344 is also configured to operate the heater unit 332 in an effort to maintain the temperature on the surface of the image receiving member 312 in a range of about 55 degrees Celsius, plus or minus 5 degrees Celsius. The image receiving member 312 inherently experiences convective heat losses as the exposed surface areas of the image receiving member 312 lose heat as the image receiving member 312 rapidly spins in the air. Additionally, contact of the print media 316 with the image receiving member 312 affects the surface temperature of the image receiving member 312. Accordingly, in low duty cycle printing, the heater unit 332 must supply heat to the image receiving member 312 at some interval that maintains the temperature of the member surface within the acceptable temperature range.

The printing process described above requires that the printer components be maintained within a relatively narrow temperature range. Print image defects can occur if the temperature of the printer components exceeds or falls below the ranges of acceptable temperatures. If the temperature is too low, for example, the ink image may not spread under pressure in the nip. If the temperature is too high, for example, transfer from the image receiving member to print media may be poor. Thus, printing devices commonly include temperatures sensors to measure surface temperatures and controllers to operate heaters or fans to maintain acceptable temperatures. When the temperature sensors measure a temperature that is too low, a heater is turned on until the temperatures sensor measurements are within the range of acceptable temperature. Conversely, when the temperature sensors measure a temperature that is too high, such as when high duty cycle printing causes over-heating of the image receiving member by repeated exposure to heated ink, a fan can be activate to cool the component until the temperature sensor measurements are within the range of acceptable temperatures. While this heating and cooling system can generally maintain the temperature of the printer components within an acceptable range, this energy expenditure is unnecessary when the printer is being used infrequently.

To address the challenges of efficient energy expenditure, printing devices commonly have the capability of operating in various states to save energy when various printer components need not be maintained at temperatures within the acceptable ranges for normal print quality. For example, after a period of inactivity, the printer typically enters a lower energy state until another imaging operation is initiated. However, when the printer is in a lower energy state and is operated to perform another imaging operation, the printer components must be reheated to temperatures within the acceptable ranges of temperatures prior to commencing the imaging operation to ensure adequate image quality. Reheating inherently consumes time and energy, each of which is generally valuable to users who are waiting for printed images. In some circumstances, a user may desire to forgo normal print quality in exchange for less reheating of the printer components, saving time and energy. Thus, operating printers in a manner that selectively reduces the time and energy spent during reheating process improves the efficiency of operating printing devices and benefits the field of printing.

### SUMMARY

A method for operating a printer has been developed that improves efficiency of operation while reducing time and energy consumed. The method includes detecting an electrical signal indicative of printer operation commencement following an inactive state, commencing monitoring of at least one component condition, comparing the at least one monitored component condition to a first predetermined threshold, the at least one component condition being at or above the first predetermined threshold being indicative that the printer is capable of printing a document with a predetermined level of image quality, and operating printer components to print a document prior to the at least one monitored component condition reaching the first predetermined threshold in response to an electrical signal being received from an user interface that indicates document printing can commence prior to the printer being capable of printing a document with the predetermined level of image quality.

A printer has been developed that prints more efficiently while reducing the time and energy consumed before printing operations commence. The printer includes a user interface configured to receive user input, a sensor operatively connected to a component in the printer, the sensor being configured to generate an electrical signal indicative of a condition of the component, and a controller operatively coupled to the sensor and the user interface. The controller is configured to detect an electrical signal indicative of printer operation commencement following an inactive state, compare the electrical signal from the sensor to a first predetermined threshold to identify whether the electrical signal generated by the sensor is at or above the first predetermined threshold, which indicates that the printer is capable of printing a document with a predetermined level of image quality, and operate printer components including the component operatively connected to the sensor to print a document prior to the electrical signal from the sensor reaching the first predetermined threshold in response to an electrical signal being received from the user interface that indicates document printing can commence prior to the printer being capable of printing a document with the predetermined level of image quality.

### BRIEF DESCRIPTION OF THE DRAWINGS

The foregoing aspects and other features of a printing device and method to provide selective control of the completion of the warm-up process and corresponding print quality are explained in the following description, taken in connection with the accompanying drawings.

FIG. 1 is a schematic block diagram of a control system within a printer.

FIG. 2 is a flowchart depicting a process which can be implemented by the control system of FIG. 1.

FIG. 3 is a schematic view of an inkjet printer configured to print images onto a rotating image receiving member and to transfer the images to recording media.

### DETAILED DESCRIPTION

For a general understanding of the environment for the printing device and method disclosed herein as well as the details for the printing device and method, reference is made to the drawings. In the drawings, like reference numerals have been used throughout to designate like elements. As used herein the term “printer” or “printing device” refers to any printing device that produces ink images on media and includes, but is not limited to, photocopiers, facsimile machines, multifunction devices, as well as direct and indirect inkjet printers. As used herein the term “controller” refers to a computing device or combination of computing devices configured to receive and process signals generated by the printer and/or by a user and operate components of the printer in response to those signals. As used herein the term “image receiving member” refers to any printer component that receives ink drops, such as an imaging drum, imaging belt, or various recording media including paper. Subsystems described in this document may or may not be present in the form depicted in the figures.

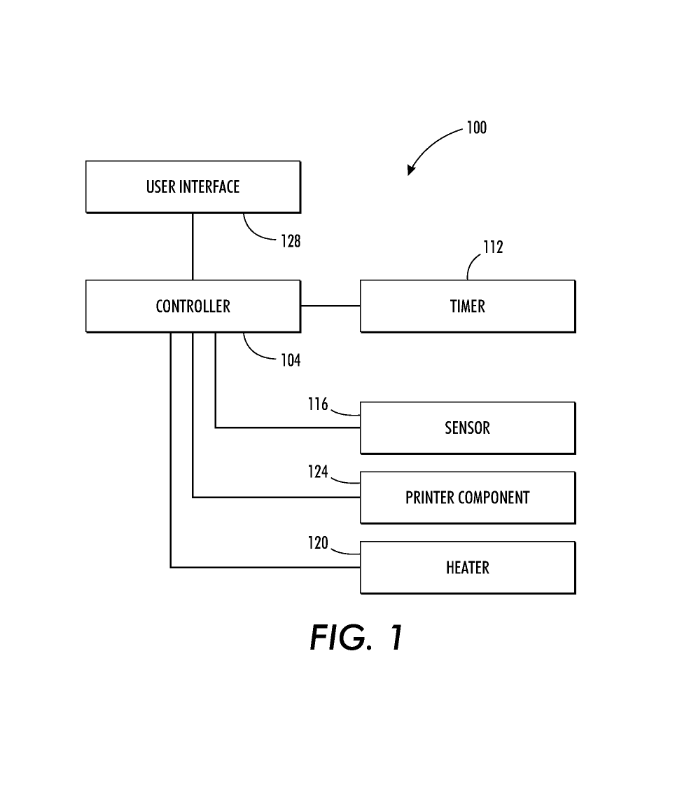

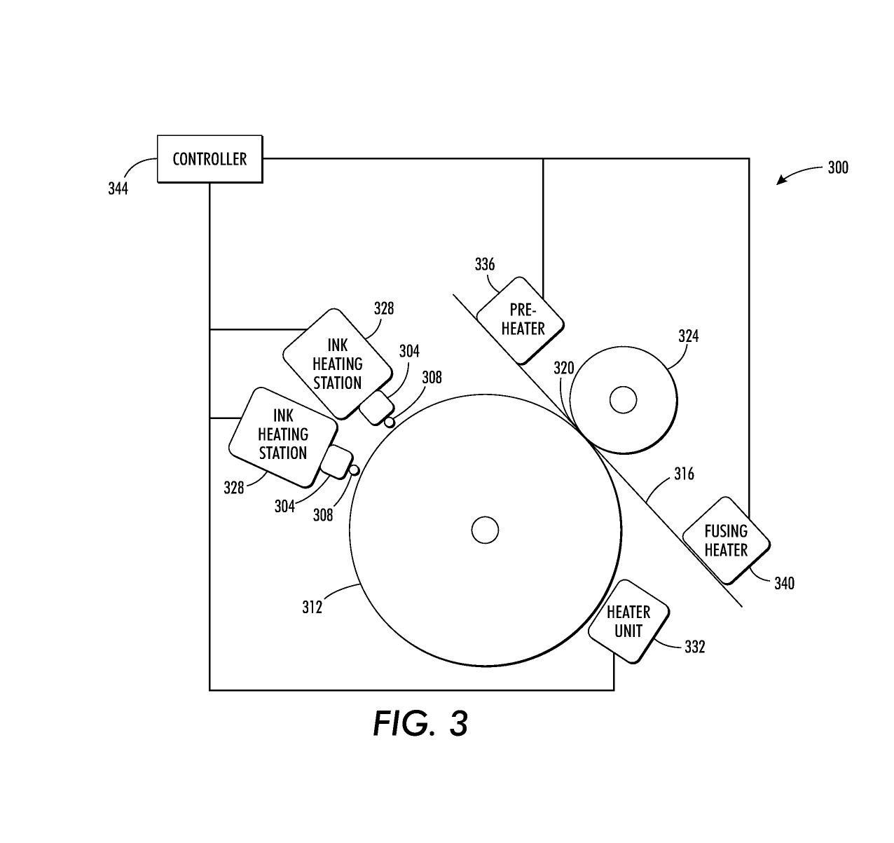

A schematic block diagram of an embodiment of a control system 100 for operating a printer like that shown in FIG. 3 to selectively reduce the time and energy spent during a warm-up process is depicted in FIG. 1. The control system 100 includes a controller 104 operatively connected to at least one timer 112, at least one sensor 116, at least one heater 120, at least one printer component 124, and a user interface 128. The heater 120 is positioned to heat the printer component 124, and the sensor 116 is positioned to measure the temperature of the printer component 124. Although the control system 100 is described below as heating and measuring the temperature of only a single printer component 124, the control system 100 can operate heaters and measure the temperature of multiple printer components each associated with a heater and a temperature sensor.

The controller 104 can be a self-contained, dedicated minicomputer having a central processor unit (CPU) with electronic storage, and a display or user interface (UI). The controller 104 reads, captures, prepares, and manages the image data flow between image input sources, such as a scanning system or an online or a workstation connection, and the inkjet printhead assemblies. The controller 104 can be implemented with general or specialized programmable processors that execute programmed instructions. The instructions and data required to perform the programmed functions can be provided on a printed circuit card or provided as a circuit in an application specific integrated circuit (ASIC). Each of the circuits can be implemented with a separate processor or multiple circuits can be implemented with discrete components or circuits provided in VLSI circuits. Also, the circuits described herein can be implemented with a combination of processors, ASICs, discrete components, or VLSI circuits.

The timer 112 can be any type of timer capable of counting an elapsed period of time and sending an electrical signal indicating the elapsed period of time to the controller 104. The timer 112 described herein is one timer capable of counting more than one different period of time and sending more than one corresponding electrical signal to the controller 104. In an alternative embodiment, the timer 112 can be configured as a plurality of timers each of which counts a different period of time and sends a corresponding electrical signal to the controller 104.

The sensor 116 can be any type of sensor capable of generating a signal indicative of a printer component condition. For illustrative purposes, in the embodiment described herein, the sensor 116 is a temperature sensor. In alternative embodiments, however, the sensor 116 can be any type of sensor configured to sense a characteristic of a printer component 124 and send an electrical signal corresponding to the sensed characteristic to the controller 104. The temperature sensor 116 can be any type of temperature sensor including, for example, thermocouples and variably resistive temperature sensors. The electrical signal can be a temperature dependent voltage, current, and/or resistance.

The heater 120 can be any device configured to convert electrical energy into heat energy. For example, the heater 120 can be an electrically resistive element that directly conducts heat or radiates infrared energy in response to being coupled to an electrical circuit. Therefore, when energized, the heater 120 consumes electrical energy, and when de-energized or in a standby mode, the heater 120 can consume no or very little electrical energy. Other known conductive, radiant, or convective heaters can be used.

The printer component 124 can be any generic printer component configured to be operated by a controller within the printer. For illustrative purposes, the printer components 124 described herein are any printer components 124 that are configured to be heated above the ambient temperature by the heater 120. In alternative embodiments, however, the printer components 124 can be any generic printer components. The printer components 124 can be, for example, a transfix roller, an image receiving member, and/or a printhead assembly. Additionally, the term “printer component(s)” can be used herein to describe generically a plurality of printer components 124 each having a corresponding heater 120 and temperature sensor 116.

The user interface 128 can be any known user interface configured with an input device to enable a user to input data that is converted to an electrical signal that is sent to, and interpreted by, the controller 104. For example, the user interface can include a touch screen or keypad for the input of data to the controller of the printer. The user interface 128 can optionally include an output device to enable data to be displayed for a user to view and interpret.

As mentioned above, printers commonly can be operated in different states to use varying amounts of energy. When a printer is operated in an active state, all printer components 124 of the printer and the control system 100 operate in their full capacity, consuming the greatest amount of energy. In the active state, the printer is ready to commence a print operation at any time and produce prints having a predetermined level of image quality. In order to produce a print having this level of image quality, each printer component 124 of the printer functions within an acceptable range of its optimal level. For example, the ink heater is heating the ink in the printer to a temperature within an acceptable range for the predetermined level of image quality prints. When ink is heated to a temperature within this range, the ink heater is functioning at or near the optimal level to produce a print having the predetermined image quality.

When a printer is operated in a standby state, the control system 100 operates the printer to conserve electrical energy. In the standby state, the printer components 124 are maintained at temperatures below the acceptable range, which uses less energy than maintaining the printer components 124 at temperatures within the acceptable range. In the standby state, the printer is not ready to commence a print operation, but is ready to heat the printer components 124 back up to temperatures within the acceptable range. In order to produce a print having the predetermined image quality, a printer in a standby state undergoes a warm-up process to reenter the active state. Once the printer components 124 are at temperatures within the acceptable range, the control system 100 operates the printer to commence the print operation. Multiple different standby states can be provided in which some or all of the subsystems are in various non-optimal and/or non-printing states. These various standby states can be based on operational parameters, such as, for example, printer duty cycle history and/or job size and/or elapsed time from the most recent printing job.

When a printer is operated in a sleep state, the control system 100 operates the printer to conserve even more electrical energy. In the sleep state, the printer components 124 are not heated by heaters 120 and, thus, are at temperatures below the acceptable range. The more time that the printer spends in the sleep state, the more the temperature of the printer components 124 decreases until the temperature of the printer components 124 reaches the ambient temperature. In the sleep state, the printer is not ready to commence a print operation, but is essentially turned off. In order to produce a print having the predetermined image quality, a printer in a sleep state undergoes a warm-up process to reenter the active state. The longer the printer is in the sleep state and the closer the temperature of the printer components 124 is to the ambient temperature, the more time and energy the warm-up process requires to heat the printer components 124 back to temperatures within the acceptable range. Once the printer components 124 are at temperatures within the acceptable range, the control system 100 operates the printer to commence the print operation.

The advantage of the different states of operation is the increased efficiency of energy expenditure. To transition between the states of operation, printing devices commonly include the timer 112 to count elapsed amounts of time and the controller 100 to compare the elapsed amounts of time to thresholds to determine in which state the printer can be operated efficiently. For example, the timer 112 counts elapsed time between print operations and sends an electrical signal corresponding to the elapsed time to the controller 100 which then compares the elapsed time to a standby threshold. The timer 112 resets after each imaging operation and begins counting the elapsed time again until the next print operation. Once the printer has been sufficiently inactive that the elapsed time between print operations reaches the standby threshold, the controller 100 operates the printer to enter the lower power or standby state. In the standby state, less energy is wasted to maintain the temperature of printer components 124 while the printer is not being consistently used.

Additionally, the timer 112 also counts an amount of time the printer spends in the standby state and the controller 104 compares the standby time to a sleep threshold. The timer 112 resets after each imaging operation and begins counting the standby time again when the printer reenters the standby state. Once the printer has been in the standby state long enough that the standby time reaches the sleep threshold, the controller 100 operates the printer to turn off or enter the sleep state in which the printer components 124 are no longer heated. In the sleep state, even less energy is consumed to maintain the temperature of printer components 124 while the printer is not being used for an extended period of time.

The disadvantage of operating the printer in different energy states is that the warm-up process that the printer undergoes to reenter the active state from either the standby or the sleep state can be time-consuming, especially if the printer was in the sleep state for an extended length of time. Some circumstances exist in which a user cannot, or does not want to, wait for the duration of the entire warm-up process before obtaining a printed image. In some circumstances, a print operation can be commenced before the warm-up process is completed. Printing before the warm-up process is completed is referred to herein as “expedited printing” and allows a print operation to commence before all of the printer components 124 have been reheated to temperatures within the acceptable range for the predetermined image quality. While expedited printing produces a printed image after less wait time and consumes less energy, the image quality can be compromised because the printer components 124 are not reheated to temperatures within the acceptable ranges for producing prints having the predetermined image quality. Accordingly, balancing the warm-up time and the desired image quality results in an optimal printing experience based on user expectations.

As described below, a user can make an expediency selection to print an image using expedited printing. When the controller 104 detects a print operation while the printer is in the standby or sleep state, the control system 100 operates the printer to commence the warm-up process which includes a set of thresholds to be met by various printer components 124 to indicate to the control system 100 that the printer is ready to produce prints having the predetermined image quality. The user can then utilize the user interface 128 to send an electronic signal corresponding to the expediency selection to the controller 104. Once a user has made an expediency selection, the control system 100 implements a method that selectively controls the heaters 120 to complete all or part of the warm-up process according to a minimally acceptable corresponding image quality.

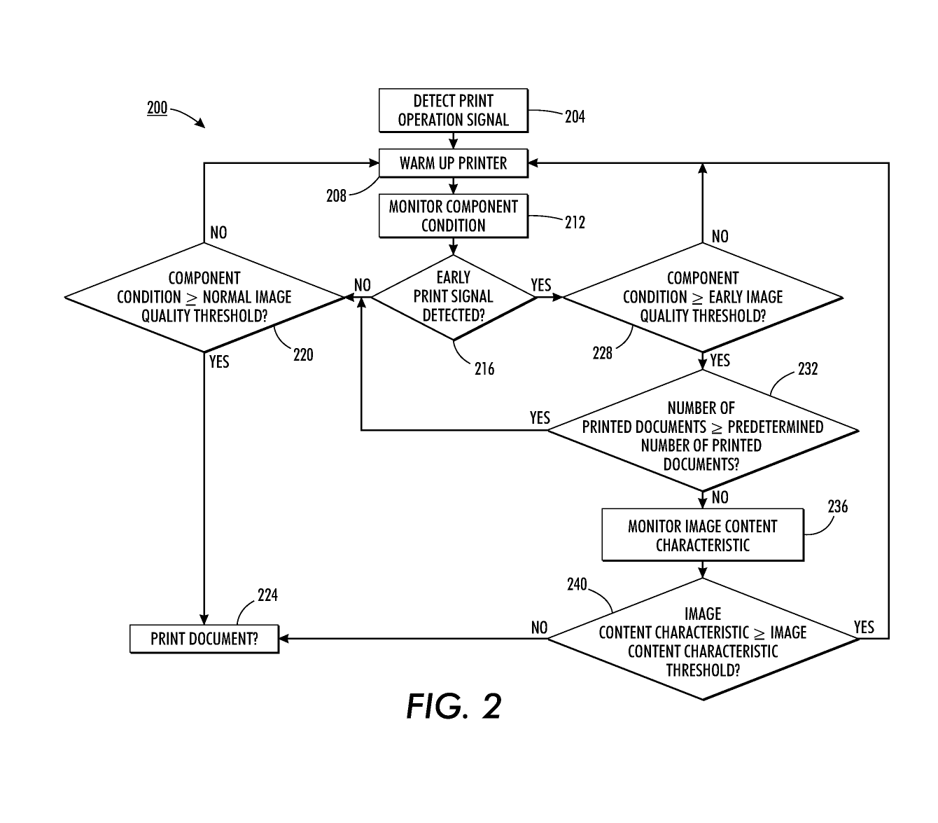

The flowchart of FIG. 2 illustrates the method 200 that the control system 100 implements to selectively control the completion of the warm-up process. The method 200 begins when the system 100 is in a standby or sleep state and the controller 104 detects an electrical signal indicating a print job (block 204). The control system 100 then operates the printer to commence the warm-up process (block 208). The reader should understand that the warm-up process includes bringing any and all printer components 124 to their respective thresholds indicating that the printer is ready to produce prints having the predetermined image quality. The control system 100 also operates the controller 104 to monitor component conditions of various printer components 124 to determine if each printer component 124 reaches its threshold indicating that the printer component 124 is within the acceptable range to produce prints having the predetermined image quality (block 212). The component conditions of various printer components 124 can include any corresponding relevant quantitative values. The controller 104 then checks to see if a user has operated the user interface 128 to make an expediency selection indicating that the print job does not require the predetermined image quality, in which case the print job can be performed with expedited printing before all of the thresholds for the printer components 124 have been reached (block 216).

If the controller 104 does not detect an expediency selection signal from the user interface 128 indicating that the print job can be completed with expedited printing, the controller 104 checks to see if the sensors 116 indicate that the component conditions of the printer components 124 have met their thresholds to indicate that the printer is ready to produce prints having the predetermined image quality (block 220). If the sensors 116 indicate that the component conditions of the printer components 124 have not met the thresholds to produce prints having the predetermined image quality, the control system 100 operates the printer to return to implementing the warm-up process (block 208). If the sensors 116 indicate that the component conditions of the printer components 124 have met their thresholds to produce prints having the predetermined image quality, the controller 104 operates the printer to commence the print operation and print the document (block 224).

If the controller 104 does detect a signal from the user interface 128 indicating an expediency selection, the controller 104 checks to see if the sensors 116 indicate that the component conditions of the printer components 124 have met their thresholds to indicate that the printer is ready to produce prints having minimally acceptable image quality (block 228). “Minimally acceptable image quality” means image quality that is lower than the predetermined image quality but still possesses an image quality acceptable to the user. If the sensors 116 indicate that the component conditions of the printer components 124 have not met the thresholds to produce prints having minimally acceptable image quality, the control system 100 operates the printer to return to implementing the warm-up process (block 208).

If the sensors 116 indicate that the component conditions of the printer components 124 have met their thresholds to produce prints having minimally acceptable image quality, the controller 104 then checks a number of print operations that have been successively performed using expedited printing (block 232). If too many print operations are completed before the printer has completed a full warm-up process, the quality of an increasing number of subsequent print operations can be compromised, even if the user does select expedited printing for the subsequent print operations. This compromise may occur due to a degrading condition of one or more subsystems, for example, non-transferred ink buildup on the image transfer surface. Accordingly, the controller compares a number of successive print operations performed using expedited printing to a predetermined threshold number of print operations. If the number of successive print operations performed using expedited printing reaches or exceeds the threshold number, the controller 104 operates the printer to return to the non-expedited printing standards and checks to see if the sensors 116 indicate that the component conditions of the printer components 124 have met their thresholds to produce prints having the predetermined image quality (block 220).

If the controller 104 does not detect that the number of successive print operations performed using expedited printing has reached the threshold number, the controller 104 then monitors image content characteristics (block 236). Image content characteristics can include, for example, image density, image resolution, an amount of ink to print the image, the distribution of ink on the print media, the complexity of the image to be printed, whether the image is to be printed using colored ink, and/or specific aspects of the colors used to produce an image, such as secondary or tertiary colors (one color upon another). Additionally, the print job size may affect how or whether or not the expedited print mode is utilized and may do so regardless of user mode selection. For example, a job size of four images may be acceptable in an expedited print mode where a job size of five pages may not be. The controller 104 compares the image content characteristics to predetermined image content characteristic thresholds to determine whether, based on the type of image to be printed, the print operation should be performed using expedited printing (block 240). If the controller 104 determines that the image content characteristics meet or exceed the image content characteristic thresholds, the controller 104 operates the printer to return to implementing the warm-up process (block 208). If the controller 104 determines that the image content characteristics do not meet or exceed the image content characteristic thresholds, the controller 104 operates the printer to commence the print operation and print the document (block 224).

In an alternative embodiment, if the user indicates that the print job can be completed using expedited printing, the controller 104 compares the signal of one sensor 116 corresponding to one component condition of one printer component 124 to the corresponding threshold for prints having the predetermined image quality and allows the print process to proceed if the sensor 116 indicates that the one component condition reaches its corresponding threshold. For example, the controller 104 can compare the temperature of the image receiving member to the corresponding temperature threshold for prints having the predetermined image quality and when the temperature of the image receiving member reaches that threshold, regardless of the condition of the other printer components, operate the printer to continue the print process.

In another alternative embodiment, if the user indicates that the print job can be completed using expedited printing, the controller compares the signals of multiple sensors 116 corresponding to multiple component conditions of multiple printer components 124 to their corresponding thresholds for prints having normal image quality and allows the print process to proceed if any one of the sensors 116 indicates that the component condition reaches its corresponding threshold. For example, the controller 104 can compare the temperature of the ink heater to the corresponding temperature threshold, can compare the temperature of the image receiving member to the corresponding temperature threshold, and can compare the temperature of the print media to the corresponding temperature threshold. Then, when any one of the ink heater, the image receiving member, or the print media reaches its corresponding temperature threshold, regardless of the condition of the other printer components, the controller 104 operates the printer to continue the print process. Note that references to the print media temperature are references to indirect temperatures and actually refer to the device temperature that causes media to elevate in temperature as the media passes en route to the transfix nip.

In another embodiment, if the user indicates that the print job can be completed using expedited printing, the controller 104 compares the signal of one sensor 116 corresponding to one component condition of one printer component 124 to the corresponding threshold for prints having minimally acceptable image quality and allows the process to proceed if that one sensor 116 indicates that the component condition reaches its corresponding threshold. For example, the controller 104 can compare the temperature of the image receiving member to the corresponding temperature threshold for prints having minimally acceptable image quality and when the temperature of the image receiving member reaches that threshold, regardless of the condition of other printer components, continue the print process and compare the number of print jobs successively completed using expedited printing to the predetermined number.

In yet another embodiment, if the user indicates that the print job can be completed using expedited printing, the controller 104 compares the signals of multiple sensors 116 corresponding to multiple component conditions of multiple printer components 124 to their corresponding thresholds for prints having minimally acceptable image quality and allows the print process to proceed if any one of the sensors 116 indicates that the component condition reaches its corresponding threshold. For example, the controller 104 can compare the temperature of the ink heater to the corresponding temperature threshold, can compare the temperature of the image receiving member to the corresponding temperature threshold, and can compare the temperature of the print media to the corresponding temperature threshold. Then, when any one of the ink heater, the image receiving member, or the print media reaches its corresponding temperature threshold, regardless of the condition of the other printer components, the controller 104 operates the printer to continue the print process and compare the number of print jobs successively completed using expedited printing to the predetermined number.

In another alternative embodiment, the printer can include a default setting wherein the controller 104 automatically applies expedited printing processes, regardless of whether a user has made an expediency selection. In another alternative embodiment, the printer can include a default setting wherein the user can utilize the user interface 108 to either select or opt out of expedited printing rather than to make an expedited selection. In another alternative embodiment, the printer can include a controller 104 programmed to implement expedited printing at particular times of day and to implement non-expedited printing at particular times of day. In another alternative embodiment, the printer can include a controller 104 programmed to implement expedited printing if the timer 112 has counted a particular amount of elapsed time since the last performed print operation and to implement non-expedited printing if the timer 112 has not counted a particular amount of elapsed time since the last performed print operation.

In yet another alternative embodiment, expedited printing can be enabled by modifying one or more non-thermal printing conditions. One example involves slowing the media passage through the transfix nip. Another example would be to modify the transfix pressure in a printer enabled to change that pressure. One or more such modified printing conditions can be implemented depending on the image content or job size. Such printing condition modifications can enable expedited printing in some circumstances where sufficient image quality would otherwise not be obtainable.

It will be appreciated that some or all of the above-disclosed features and other features and functions or alternatives thereof, may be desirably combined into many other different systems, apparatus, devices or applications. Various presently unforeseen or unanticipated alternatives, modifications, variations, or improvements therein may be subsequently made by those skilled in the art, which are also intended to be encompassed by the following claims.

What is claimed is:

1. A method for operating a printer comprising:
detecting an electrical signal indicative of printer operation commencement following an inactive state;
commencing monitoring of at least one component condition;
comparing the at least one monitored component condition to a first predetermined threshold, the at least one component condition being at or above the first predetermined threshold being indicative that the printer is capable of printing a document with a predetermined level of image quality; and
operating printer components to print a document prior to the at least one monitored component condition reaching the first predetermined threshold in response to an electrical signal being received from an user interface that indicates document printing can commence prior to the printer being capable of printing a document with the predetermined level of image quality.

2. The method of claim 1 further comprising:
counting a number of documents printed prior to the at least one monitored component condition reaching the first predetermined threshold;
comparing the counted number of printed documents to a predetermined number of printed documents; and
stopping operation of the printer components to print documents prior to the at least one monitored component condition reaching the first predetermined threshold in response to the counted number of printed documents reaching the predetermined number of printed documents.

3. The method of claim 1 further comprising:
operating the printer components to print documents prior to the at least one monitored component condition reaching the first predetermined threshold in response to the at least one monitored component condition reaching a second predetermined threshold that is less than the first predetermined threshold.

4. The method of claim 1, the monitoring of the at least one component condition further comprising:
monitoring a plurality of component conditions;
comparing each component condition in the plurality of component conditions to a corresponding first predetermined threshold; and
operating the printer components to print the document prior to any of the component conditions reaching the corresponding first predetermined threshold in response to detection of the electrical signal indicating document printing can commence prior to the printer being capable of printing a document with the predetermined level of image quality.

5. The method of claim 1, the monitoring of the at least one component condition further comprising:
monitoring a plurality of component conditions;
comparing each component condition in the plurality of component conditions to a corresponding first predetermined threshold; and
operating the printer components to print the document in response to only one of the component conditions in the plurality of component conditions reaching the corresponding first predetermined threshold.

6. The method of claim 4 further comprising:
comparing each component condition in the plurality of component conditions to a corresponding second predetermined threshold that is less than the corresponding first predetermined threshold in response to the electrical signal being detected that is indicative that document printing can commence prior to the printer being capable of printing a document with the predetermined level of image quality; and
operating the printer components to print the document in response to only one of the component conditions in the plurality of component conditions reaching the corresponding second predetermined threshold.

7. The method of claim 1 further comprising:
receiving the electrical signal from the user interface that is indicative that document printing can commence prior to the printer being capable of printing a document with the predetermined level of image quality;
commencing monitoring at least one image content characteristic of an image to be printed;
comparing the at least one image content characteristic to a first predetermined image content characteristic threshold, the at least one image content characteristic being below the first predetermined image content characteristic threshold being indicative that the image to be printed is able to be printed with a level of image quality that is below the predetermined level of image quality; and
operating printer components to print a document prior to the at least one monitored component condition reaching the first predetermined threshold.

8. The method of claim 3 further comprising:
modifying at least one non-thermal printing condition prior to operating the printer to print documents.

9. The method of claim 8, the modification of the at least one non-thermal printing condition further comprising:
modifying one of a speed of media passing through a transfix nip and a pressure exterted by a roller forming the transfix nip.

10. The method of claim 8 further comprising:
modifying the at least one non-thermal printing condition with reference to one of an image content and job size.

11. A printer comprising:
a user interface configured to receive user input;
a sensor operatively connected to a component in the printer, the sensor being configured to generate an electrical signal indicative of a condition of the component; and
a controller operatively coupled to the sensor and the user interface, the controller configured to:
detect an electrical signal indicative of printer operation commencement following an inactive state;
compare the electrical signal from the sensor to a first predetermined threshold to identify whether the electrical signal generated by the sensor is at or above the first predetermined threshold, which indicates that the printer is capable of printing a document with a predetermined level of image quality; and
operate printer components including the component operatively connected to the sensor to print a document prior to the electrical signal from the sensor reaching the first predetermined threshold in response to an electrical signal being received from the user interface that indicates document printing can commence prior to the printer being capable of printing a document with the predetermined level of image quality.

12. The printer of claim 11 the controller further configured to:
count a number of documents printed prior to the electrical signal from the sensor reaching the first predetermined threshold;
compare the counted number of printed documents to a predetermined number of printed documents; and
stop operation of the printer components to print documents prior to the at least one monitored component condition reaching the first predetermined threshold in response to the counted number of printed documents reaching the predetermined number of printed documents.

13. The printer of claim 11 the controller further configured to:
operate the printer components to print the document prior to the electrical signal from the sensor reaching the first predetermined threshold in response to the electrical signal from the sensor reaching a second predetermined threshold that is less than the first predetermined threshold.

14. The printer of claim 11 further comprising:
a plurality of sensors, each sensor being operatively connected to a component in the printer that is different than the other components operatively connected to the other sensors in the plurality of sensors, and each sensor being configured to generate an electrical signal indicative of a condition of the component operatively connected to the sensor; and
the controller is operatively connected to each of the sensors in the plurality of sensors and the controller is further configured to:
compare the electrical signal received from each sensor in the plurality of sensors to a first predetermined threshold corresponding to the component operatively connected to the sensor; and
operate the printer components to print the document prior to any of the electrical signals generated by the sensors in the plurality of sensors reaching the first predetermined threshold to which the electrical signal is compared in response to detection of the electrical signal that indicates document printing can commence prior to the printer being capable of printing the document with the predetermined level of image quality.

15. The printer of claim 11 further comprising:
a plurality of sensors, each sensor being operatively connected to a component in the printer that is different than the other components operatively connected to the other sensors in the plurality of sensors, and each sensor being configured to generate an electrical signal indicative of a condition of the component operatively connected to the sensor; and
the controller is operatively connected to each of the sensors in the plurality of sensors and the controller is further configured to:
compare the electrical signal received from each sensor in the plurality of sensors to a first predetermined threshold corresponding to the component operatively connected to the sensor; and
operate the printer components to print the document prior to only one of the electrical signals generated by the sensors in the plurality of sensors reaching the first predetermined threshold to which the electrical signal is compared in response to detection of the electrical signal that indicates document printing can commence prior to the printer being capable of printing the document with the predetermined level of image quality.

16. The printer of claim 14 the controller further configured to:
compare each electrical signal received from each sensor in the plurality of sensors to a second predetermined threshold corresponding to the component operatively connected to the sensor that is less than the corresponding first predetermined threshold in response to the electrical signal being detected that is indicative that document printing can commence prior to the printer being capable of printing the document with the predetermined level of image quality; and
operate the printer components to print the document in response to only one of the electrical signals from the sensors in the plurality of sensors reaching the second predetermined threshold corresponding to the component operatively connected to the sensor.

17. The printer of claim 11 the controller further configured to:
receive the electrical signal from the user interface that indicates document printing can commence prior to the printer being capable of printing a document with the predetermined level of image quality;
commence monitoring an image content characteristic of an image to be printed;
compare the image content characteristic to a first predetermined image content characteristic threshold, the image content characteristic being at or below the first predetermined image content characteristic threshold being indicative that the image to be printed is able to be printed with a level of image quality that is below the predetermined level of image quality; and
operate printer components to print a document prior to the at least one monitored component condition reaching the first predetermined threshold.

18. The printer of claim 13, the controller being further configured to modify at least one non-thermal printing condition prior to operating the printer to print documents.

19. The printer of claim 18, the controller being further configured to modify one of a speed of media passing through a transfix nip and a pressure exterted by a roller forming the transfix nip prior to operating the printer to print documents.

20. The method of claim 18, the controller being configured to modify the at least one non-thermal printing condition with reference to one of an image content and job size.
